(19) United States
(12) Patent Application Publication
(10) Pub. No.: US 2004/0231176 A1
(43) Pub. Date: Nov. 25, 2004

(54) Mitered moulding comparator

(76) Inventors: Alan R. Peters, Bokeelia, FL (US); Rosemary C. Peters, Bokeelia, FL (US)

Correspondence Address: ALAN R. PETERS, 16314 ESTUARY CT., BOKEELIA, FL, 33922, US

(21) Appl. No.: 10/781,515

(22) Filed: Feb. 18, 2004

Related U.S. Application Data
(60) Provisional application No. 60/448,728, filed on Feb. 21, 2003.

(51) Int. Cl. G01B 3/20

(52) U.S. Cl. 33/501.05

(57) ABSTRACT

A simple yet complete device to compare molding mitered angles & lengths commonly used in, but not limited to, the picture framing industry. This device will take pair lengths of molding placed bottom surface to bottom surface with the outer surfaces of the moldings located and centered by means of a 2 toned pattern on a plate, with the mitered surfaces abutted against a radiused tab at one end of the plate.

After centering & pushing the moldings against the radiused tab the user rubs a finger across the front end (near tab contact point) of the molding miter & at the opposite end of the molding miter.

It will be very evident if the molding miter angles, and, or, the molding lengths are not the same; as any high points or steps, as small as a few thousandths of an inch can be sensed by a finger passing across abutting sharp edged surfaces.

### BACKGROUND OF INVENTION

In the picture framing and woodworking industries mouldings & strips of lumber, plastics & metals are commonly cut at various mitered angles. (These pieces will heretofore be referred to as moulding(s). When these mouldings are cut to be used as a pair there are commonly errors in mitered angles, the prependicularity of the cut, and the moulding lengths.

To correct these errors there are commercially available miter sanders. When errors occur it is necessary to have a means of comparing the mitered angles & lengths of the cut mouldings.

This device will quickly & acurately compare the mitered angles and lengths of pairs of mouldings for equality (so, if necessary equality can be attained by sanding).

### BRIEF DESCRIPTION OF DRAWINGS

FIG. 1 Is a prospective view of the invention showing one pair of mouldings in place to be compared.

FIG. 2 Is a fragmented plan view of the invention.

FIG. 3 Is a sectional view taken along line 3-3 of FIG. 2

FIG. 4 Is a sectional view taken along line 4-4 of FIG. 2

FIG. 5 Is a fragmented sectional view taken along line 5-5 of FIG. 2

FIG. 6 Is a fragmented sectional view taken along line 6-6 of FIG. 2

At one end of plate 1 is an essentially right angled tab 3 with a radius 12 along it's formed bend length is affixed to the top surface 20 of plate 1 by means of screws 5 and pins 6. The radius 12 of tab 3 is aligned perpendicularly to the two tone colored cenrer line X created by the dark area C and the light area D of riser pad 2 and held in place by screws 5 until it is permanently fixed in place by pins 4. On the bottom surface 21 of plate 1 are affixed rubberized pads 7 at three or more positions to elevate plate 1 from it's mounting table or surface to create a non slip condition while operating the invention.

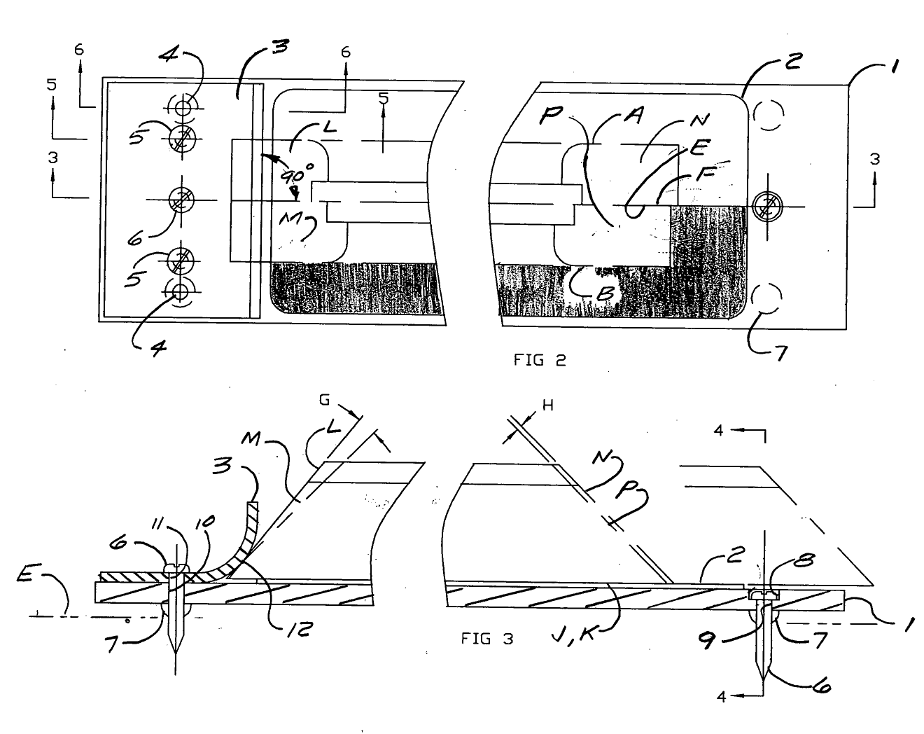

FIG. 2 is a plan view of the invention showing a pair of mouldings A & B placed in position with their bottom surfaces E & F in contact with each other and located along centerline X of the riser pad 2 and registering against the radius 12 of tab 3 with their outter surfaces J & K in contact with surfaces C & D of riser pad 2.

FIG. 3 is a fragmented sectional view along line 3-3 showing a pair of mouldings A & B with outter surfaces J & K in contact with the top surfaces C & D of riser pad 2 and mitered surfaces L & M in contact with the radius 12 of tab 3. As illustrated by angle G, if mitered surfaces L & M are not of equal angle a variance will occur at the upper corner created by mitered surfaces L & M and the upper horizontal surfaces of mouldings A & B. AS shown by gap H, if there is a variation in length between moulding A& B a step will be formed between mitered surfaces N& P of mouldings A & B. If either, or both, of afforementioned variances occur they can be easily detected by the operator passing their finger back and forth across the mouldings A & B parallel to the upper surface of plate 1, against surfaces M & L and then N & P. As little as a few thousanths of an inch can be detected. If the angles or lengths of the mouldings A & B are in variance they may be sanded on a commercially available miter sander.

Mounting screw 6 at the opposite end of plate 1 from tab 3 passes through hole 9 with it's head located in a counterbored hole 8 to a depth that will allow the head of screw 6 to be below the surface 20 of plate 1. Mounting screw 6 at the tab end of plate 1 passes through hole 11 in tab 3 and hole 10 in plate 1. Because mounting screw 6 in hole 9 and counterbore 8 is located below surface 20 of plate 1, a moulding of greater length than plate 1 can pass over top of screw 6 and will not interfere with the operation of the invention.

FIG. 4 is a cross section along line 44 showing mouldings A & B in a centralized location with their bottom surfaces E & F abutting and in line with centerline X created by top surfaces C & D of riser pad 2. Also shown is hole 9 and counterbore 8 for use by mounting screw 6 (not shown).

FIG. 5 is a fragmented sectional view along line 5-5 showing tab 3 attaching screw 5 threaded into hole 14 of plate 1. To provide for alignment of radius 12 of tab 3 to centerline X a clearance is provided in hole 13 of tab 3 to allow attainment that alignment.

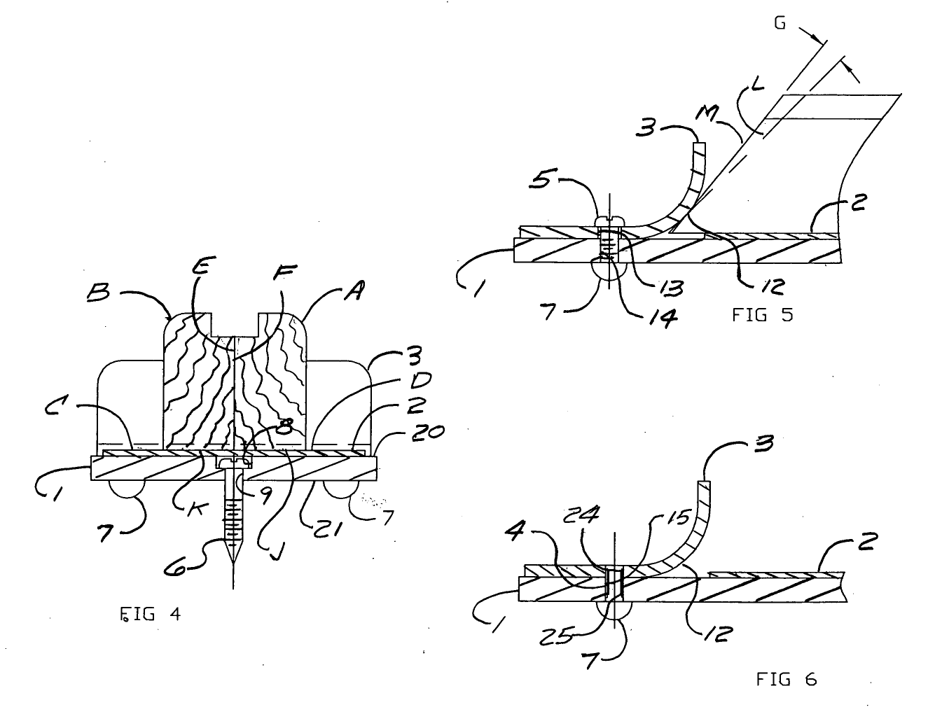

FIG. 6 is a fragmented sectional view along line 6-6 showing locating pins 4 that pass through tab 3 into plate 1. When radius 12 on tab 3 is oriented to it's correct perpendicular relationship to centerline X holes 24 in tab 3 would be transfer drilled creating holes 25 in plate 1 to allow insertion of pins 4 that will maintain correct orientation.

Thus it can be seen that the present invention provides a novel, inexpensive, and uncomplicated device for quickly and easliy checking the comparative angles & lengths of mitered moulding pairs (and the like) by means of a commonly shared centerline and commonly shared perpendicularly located radius to orient the pairs in a position to be accurately compared by the operator passing a finger, back & forth, across either or both ends of the mitered surfaces to detect any discrepancies.

### SUMMARY OF INVENTION

With this invention the user will have a means to acurately and quickly compare the mitered angles and lenghts of moulding pairs by means of a base plate having a centerally located demarkation line along it's top surface, along it's length, created by raised pad(s) attached to the top surface of the base plate to elevate the moulding pairs so that the sharp edge of the miter is not in contact with the base plate. At one end of the base plate is attached a right angle shaped tab with a radius in it's corner mounted in a manner to the base of the plate by one leg of the tab and secured to the base plate by means of screws & pins. The tab is oriented in such a manner that the radius is parrallel to the top surface of the base plate & perpendicular to the afformentioned centrally located demarkation line on the riser pad. This orientation allows that the sharp edge of the mitered moulding angle will not come in contact with the base plate or the radiused tab, as the tab will only contact the mitered angle and the outter edge of the moulding will only contact the riser pad attached to the base plate

This configuration will accomodate the possibility of the sharp edge of the mitered moulding having a burr that otherwise could mis-align the moulding during comparison. With this invention, the under side of the base plate could accomodate stick on, or otherwise attached, rubber pads to eliminate sliding when the invention is used on a solid surface.

The invention has a counterbored hole from the top surface of the base plate close to the end opposite the tab to accomodate a screw for mounting to a table or a vertical or angular wall. There is a second hole, passing through the tab portion mounted to the base plate, & the base plate, to accomodate a second mounting screw.

There are several means of providing the centrally located demarkation line on the base plate. One means would incorporate a solid surfaced base plate that has a riser pad with a centrally divided, two tone, color pattern down it's length for orientation of the moulding pairs. Another means would be having a small centrally located machined or extruded groove on the top surface of the base plate along it's entire length which could be filled with paint or the like for visiblity. A raised pad would then be applied to the top surface of the base plate on both sides of the centrally located groove. In both cases; the riser pad(s) would stop short of the tab plate so as to leave a gap to accomodate any burr on the sharp edge of the moulding.

When locating a moulding pair on the invention the best way is to first place one piece of the pair against the tab plate with it's outter surface in contact with the riser pad & it's bottom surface inline with the centrally located demarkation line & press the moulding piece against the tab. While holding the first piece of the moulding pair in place the operator would then place the second piece of the moulding pair along side the first piece with it's outter surface in contact with the riser pad and it's bottom surface in contact with the bottom surface of the first piece from moulding pair & push the second moulding into the tab. While holding the two pieces of the moulding pair in place against the tab the operator would then pass a finger back and forth the mitered surfaces horizontally. The operator will sense any differences between the first and second pieces of the moulding pair as to lengths or mitered angles to as small as a few thousandths of an inch.

By using this method of operation; an operator can compare moulding pairs that are longer than the base plate as the first moulding has already been located on the centerline for a portion of it's length.

### DETAIL DESCRIPTION OF DRAWINGS

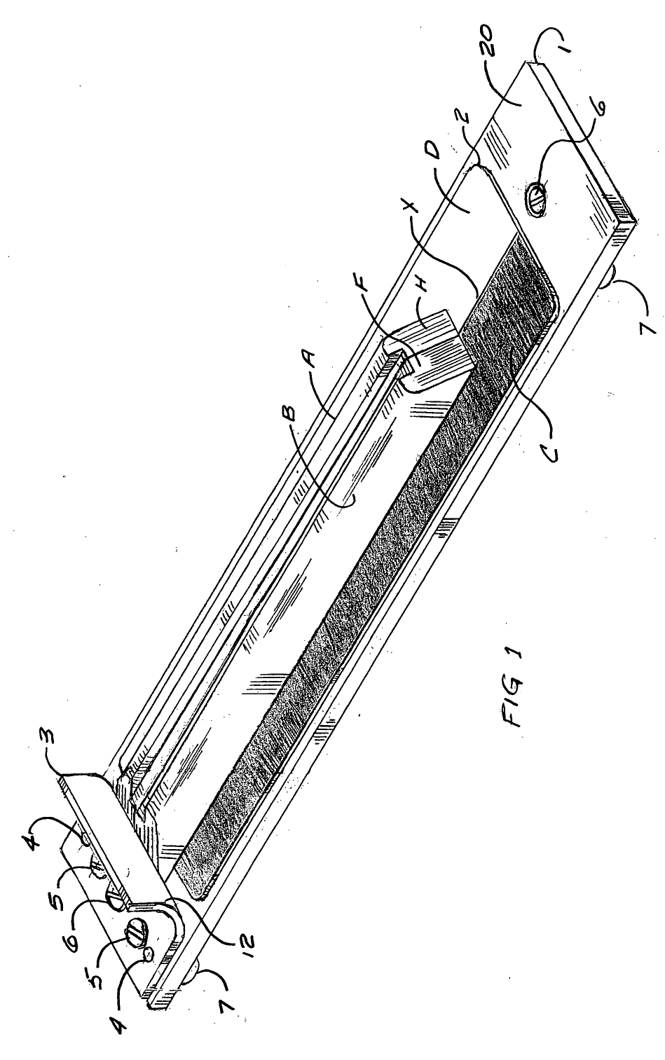

Turning to FIGS. 1 & 4 which show an overall view of the invention consisting of a rectangularly cross sectioned base of flat plate 1 of a sufficiant length to accomodate the pre cut mitered moulding pair A & B that are being compared. Affixed to the top surface 20 of plate 1 is a riser pad 2 of a given thickness to elevate surfaces J & K of moulding pieces A & B to a height sufficiant to clear any burrs that might exist on the sharp ends of the mitered mouldings that contact the radius 12. The top surface of the riser pad 2 consists of a two tone colored pattern, centrally divided down it's length with a dark side C and a light side D and essentially cenralized along the length of the plate 1 and ending short of the radius 12 tab 3.

Having thus described the invention what is claimed is:

1. A comparison device having a flat linear raised surface riser pad with a supporting substraight for supporting of the outter perimeter surface of a mitered pair of picture frame mouldings (and the like) and having a linear centerline on said linear surface, created by a two toned pattern, allowing the placement of each of the said moulding pair with their bottom surfaces abutting and on opposite sides of said centerline.
At one end of said substraight & central located about said centerline is mounted a tab having a radius at it's formed corner. Said tab is mounted in a way to said substraight that said radius is parallel to said substraight and perpendicular to said centerline. This configuration allows the moulding to register it's mitered surface against said radius and not have it's accute sharp corner in contact with said radius.

2. In cooperation with claim 1; the centerline created by a two toned pattern is on the upper surface of said raised pad that stops short of the radius of said tab so as to create a void under the outter surface of the moulding near it's accute angle. This cooperation of components allows for the accute angled tip of said moulding to not be in contact with said substraight. This is especially important when the tip of the accute angle of the mitered moulding has a burr, or other distortion, that could cause misallignment and, or, incorrect comparison of the moulding pairs.

3. In cooperation of claim 1; the use of a radius to contact the mitered angle of said mouldings allows the angle of the miter to be any degree from approximately 10 degrees up to and including 90 degrees.

4. In cooperation with claim 1; by placing one of said moulding pair pieces on said centerline and in registration with said radius then positioning the bottom surface of the second moulding piece to abutt the bottom surface of the first moulding piece, the operator will have established that both of said moulding pieces are on said centerline even if the mouldings are of greater length than the invention itself.
